(19) United States
(12) Patent Application Publication
(10) Pub. No.: US 2004/0258935 A1
(43) Pub. Date: Dec. 23, 2004

(54) Nonthermal magneto-optical recording by ultrafast photoinduced softening in ferromagnetic semiconductors

(75) Inventors: Junichiro Kono, Houston, TX (US); Jigang Wang, Houston, TX (US); Giti A. Khodaparast, Bellaire, TX (US); Hiroo Munekata, Yokosuka (JP)

Correspondence Address: CONLEY ROSE, P.C., P. O. BOX 3267, HOUSTON, TX, 77253-3267, US

(73) Assignee: William Marsh Rice University, Houston, TX (US)

(21) Appl. No.: 10/795,626

(22) Filed: Mar. 8, 2004

Related U.S. Application Data
(60) Provisional application No. 60/454,091, filed on Mar. 12, 2003.

(51) Int. Cl. B32B 25/12

(52) U.S. Cl. 428/493; 428/492

(57) ABSTRACT

A ferromagnetic III-V semiconductor material and method for nonthermally recording information on the same. In one embodiment, the method comprises providing a ferromagnetic III-V semiconductor material, wherein the semiconductor material comprises at least one Group III element, at least one Group V element, and a dopant. In addition, the method comprises exposing the ferromagnetic material to laser pulses to produce transient carriers. Further embodiments include the dopant comprising manganese.

### CROSS-REFERENCE TO RELATED APPLICATIONS

This non-provisional application claims the benefit of U.S. Provisional Application No. 60/454,091, filed on Mar. 12, 2003, which is hereby incorporated by reference in its entirety.

### STATEMENT REGARDING FEDERALLY SPONSORED RESEARCH OR DEVELOPMENT

This invention was made with government support under Grant No. MDA 972-00-1-0034 by DARPA and Grant No. DMR-0134058 by NSF.

### BACKGROUND OF THE INVENTION

1. Field of the Invention

This invention relates to the field of information recording and more specifically to the field of non-thermal recordation of information on magnetic media.

2. Background of the Invention

There has been increasing interest in the use of magneto-optical methods to record information. The typical process for such recordation is thermo-magnetic writing. Thermo-magnetic writing uses a laser and a magnet to store and retrieve data. Typically, a magneto-optical film such as rare earth-transition metal alloys (RE-TM) with the general structure given by (Tb_{y}Gd_{1-y})ₓ(Fe₂Co_{1-z})₁₋ₓ is heated locally with a laser. As the temperature of the film increases and approaches the curie temperature (T_{c}), the coercive field (H_{c}), which is also known as coercivity, begins to dissipate. When the magnetic surface is increased to a temperature whereby H_{c} is less than an external magnetic field (Hₑₓₜ), the film is then modified by Hₑₓₜ, and data is written to the disk.

Drawbacks include the process being dependent on the heat transfer between the laser and the magneto-optical film. Typically, the heat transfer rate is more than 1 ns. Such a heat transfer sets the fundamental limit to the data writing rate, which is typically 30 MB/s.

Consequently, there is a need for a more efficient and faster method for storage of information in magnetic media. In addition, there is a need for a more efficient storage media for information. Further needs include a faster method for writing information to a magnetic storage media.

### BRIEF SUMMARY OF SOME OF THE PREFERRED EMBODIMENTS

These and other needs in the art are addressed in one embodiment by a storage medium, wherein the storage medium comprises a ferromagnetic semiconductor. The storage medium comprises at least one Group III element; at least one Group V element; and a dopant. In addition, the storage medium comprises an original coercivity and an expected photo-modified coercivity, wherein the expected photo-modified coercivity is lower than the original coercivity.

In another embodiment, the invention comprises a method for nonthermally recording information on a ferromagnetic semiconductor material. The method comprises providing a ferromagnetic III-V semiconductor material, wherein the ferromagnetic semiconductor material comprises at least one Group III element, at least one Group V element, and a dopant. In addition, the method comprises exposing the ferromagnetic semiconductor material to laser pulses to produce transient carriers.

Further embodiments include a method for nonthermally modifying a ferromagnetic III-V semiconductor material, wherein the coercivity is preferably modified. The method comprises providing the ferromagnetic III-V semiconductor material, wherein the ferromagnetic semiconductor material comprises at least one Group III element, at least one Group V element, and a dopant. Moreover, the method comprises exposing the ferromagnetic semiconductor material to laser pulses to produce transient carriers, wherein the transient carriers interact with the dopant to modify magnetic properties of the ferromagnetic semiconductor material, more specifically to modify the coercivity of the ferromagnetic semiconductor material (preferably a Mn-doped or Cr-doped III-V semiconductor material).

A further embodiment includes a method for providing a transient decrease of coercivity in a hysteresis loop of a ferromagnetic III-V semiconductor material. The method comprises providing the ferromagnetic III-V semiconductor material, wherein the ferromagnetic III-V semiconductor material comprises at least one Group III element, at least one Group V element, and a dopant. In addition, the method comprises exposing the ferromagnetic III-V semiconductor material to ultrashort laser pulses having a predetermined wavelength to produce transient carriers within the ferromagnetic III-V semiconductor material.

An additional embodiment includes a method for increasing the carrier density in a ferromagnetic III-V semiconductor material. The method comprises exposing the ferromagnetic semiconductor material to ultrashort laser pulses with a predetermined wavelength.

It will therefore be seen that the technical advantages of this invention include non-thermally using ultrashort laser pulses to reduce coercivity in a ferromagnetic semiconductor material to record information on the ferromagnetic semiconductor material, thereby eliminating problems encountered by using thermo-magnetism to record such information. For instance, problems with the writing rate are overcome by using the ultrashort laser pulses.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates one diagram showing non-thermal recording of information on a III-V ferromagnetic semiconductor material;

FIG. 2 illustrates a schematic band diagram of an InMnAs/GaSb sample with a relevant interband optical transition that produces carriers;

FIGS. 3(a) and (b) illustrate the magnetic field dependence of a MOKE signal showing an ultrafast softening process; and

FIGS. 4 (a)-(e) illustrate photo-induced magnetization dynamics.

### DETAILED DESCRIPTION OF THE PREFERRED EMBODIMENTS

It has been surprisingly discovered that pulses of light can modify magnetic properties of III-V ferromagnetic semiconductors. Such discovery includes an ultrafast photo-induced softening process that comprises decreasing the coercivity of a ferromagnetic III-V semiconductor with photo-induced transient carriers. The ferromagnetic III-V semiconductor is doped with a dopant (preferably Mn), and the photo-induced transient carriers are preferably provided by a light source, preferably a laser. Without being limited by theory, it is believed that, since laser pulses can create a transient distribution of de-localized carriers (transient carriers), significant modifications can be anticipated in the exchange interaction between localized Mn spins and transient carrier spins. Moreover, it is believed that photo-generated transient carriers significantly decrease coercivity (H_{c}) while maintaining the saturation magnetization of the ferromagnetic semiconductor. It is further believed that such effects by the photo-generated transient carriers are attributed to the carrier enhanced Mn—Mn exchange interaction, which increases the domain wall energy (magnetic polaron diameter) in the domain picture (particle picture) for coercivity mechanisms. Coercivity (H_{c}) is defined herein as the external magnetic field needed to reduce the magnetization of a ferromagnet to zero.

The storage medium of the present invention comprises a semiconductor material. The semiconductor material comprises at least one Group III element from the Periodic Table of the Elements and at least one Group V element from the Periodic Table of the Elements. The semiconductor also comprises a dopant. Suitable dopants include manganese (Mn) and chromium (Cr). It is to be understood that the dopant replaces the Group III atoms. Preferable Group III and V elements are those elements having a high curie temperature (T_{c}) and more preferably with a T_{c} above room temperature. Examples of suitable combinations of such materials include Ga₁₋ₓMn_{y}As, Ga₁₋ₓMnₓN_{y} (In_{0.53}Ga_{0.47})₁₋ₓMnₓAs, and In₁₋ₓMnₓAs. The most preferable combination is Ga₁₋ₓMnₓN, which has a T_{c} above room temperature. It is to be understood that “x” represents the Mn composition. It is to be further understood that room temperature comprises temperatures typically between about 20° C. and about 30° C. However, the present invention is not limited to such a room temperature range as it is understood that room temperature can vary due to the setting and other parameters. T_{c} is defined herein as the ferromagnetic transition temperature, above which the material no longer possesses macroscopic magnetic order due to thermal randomization.

In the undoped, host III-V semiconductor, Group V elements comprise about 50 molar % of the semiconductor, and Group III elements comprise about 50 molar % of the semiconductor. The dopant (preferably Mn or Cr) replaces up to about 10 molar % or less of the Group III elements.

The ferromagnetic semiconductor material also comprises an original coercivity (H_{c}⁰) and an expected photo-modified coercivity (H_{c}^{mod}), wherein H_{c}^{mod} is less than H_{c}⁰. H_{c}⁰ comprises the coercivity of the ferromagnetic semiconductor material before it is exposed to the laser pulses. It is to be understood that values for H_{c}⁰ vary depending on factors such as sample type, sample preparation methods, and the like. H_{c}^{mod} comprises the coercivity of the ferromagnetic semiconductor material after it is exposed to the laser pulses. H_{c}^{mod} values for the ferromagnetic semiconductor materials also can vary depending on factors such as sample type, sample preparation methods, laser excitation conditions, and the like. For instance, under high excitation conditions, H_{c}^{mod} can be at or near zero. The storage medium is preferably prepared in an external magnetic field (Hₑₓₜ). For instance, Hₑₓₜ can be supplied by a small permanent magnet or an electromagnet. Hₑₓₜ is lower than H_{c}⁰ but larger than H_{c}^{mod}.

It is to be understood that ferromagnets have a permanent magnetic field and an original magnetization direction. Hₑₓₜ has a magnetization direction opposite to that of the ferromagnet's original magnetization direction. H_{c}⁰ represents the strength of Hₑₓₜ to reduce the magnetization of the ferromagnet to zero and flip its original magnetization direction to the opposite direction, which is that of Hₑₓₜ. It is to be further understood that ferromagnets having a large coercivity are typically referred to as hard magnets, and ferromagnets having a small coercivity are typically referred to as soft magnets. Without limiting the present invention, soft magnets typically have a coercivity between about 10⁻⁷ and about 10⁻⁴ T, and hard magnets typically have a coercivity between about 10⁻⁴ and about 1 T. It has been surprisingly discovered that coercivity for a ferromagnetic semiconductor material can be controlled by ultrashort laser pulses. Therefore, to soften the ferromagnetic semiconductor material, the ferromagnetic semiconductor material is exposed to the laser pulses in the external magnetic field. It has also been discovered that coercivity is reduced temporarily when the ferromagnetic semiconductor material is exposed to the laser pulses. Therefore, when a light source exposes the ferromagnetic semiconductor material to laser pulses in the external magnetic field, the ultrafast creation of transient carriers in the ferromagnetic semiconductor material softens the ferromagnetic semiconductor material, which comprises a reduction in its coercivity. Such softening can occur when the transient carriers interact with the Mn ions in the ferromagnetic semiconductor material to reduce its coercivity. Such softening can result in magnetization reversal when the coercivity (H_{c}) for the ferromagnetic semiconductor material is reduced to H_{c}^{mod}. For such reversal, the strength of Hₑₓₜ is greater than that of H_{c}^{mod} but less than that of H_{c}⁰. The softening is temporary, and the coercivity of the ferromagnetic semiconductor material will return to H_{c}⁰. However, the magnetization direction will remain reversed. No substantial heat transfer occurs between the laser pulses and the ferromagnetic semiconductor material.

The present invention further comprises a method of recording information on the III-V ferromagnetic semiconductor material. Such method is a nonthermal recording of data. The method comprises providing the ferromagnetic semiconductor material with a H_{c}⁰ and H_{c}^{mod}, with H_{c}^{mod} lower than H_{c}⁰. The ferromagnetic semiconductor material also has an original magnetization direction. The method further comprises exposing the ferromagnetic semiconductor material to at least one laser pulse to produce transient carriers in the ferromagnetic semiconductor material. The ferromagnetic semiconductor material is preferably exposed to the laser pulses in an external magnetic field (Hₑₓₜ), which has a magnetization direction opposite that of the original magnetization direction of the ferromagnetic semiconductor material. The external magnetic field also has a strength less than H_{c}⁰ but greater than H_{c}^{mod}. After exposing the ferromagnetic semiconductor material to the laser pulses, the transient carriers are produced, which interact with the Mn ions to reduce the coercivity of the ferromagnetic semiconductor material to H_{c}^{mod}. Upon reaching H_{c}^{mod}, the original magnetization direction of the ferromagnetic semiconductor material reverses to the opposite direction. The information recorded includes video, audio, or any data encoded in binary format, i.e., through the magnetization directions of the material. It is to be understood that the above-described non-thermal magnetization reversal can be utilized to record bits of information onto magneto-optical disks by switching the magnetization directions.

Preferably, lasers are used as the light source. Any laser that matches the band gap of the ferromagnetic semiconductor material can be used. Preferable lasers include a compact semiconductor laser diode, an optical parametric amplifier, and any other commercially available opulsed lasers. More preferably, the laser comprises a compact semiconductor laser diode. The laser pulses have sufficient pulse energy to produce an increase in density of carriers in the ferromagnetic semiconductor material. The density of the transient carriers is comparable or larger than the background carrier density (which can be 10¹⁹ to 10²⁰ cm⁻³) in the ferromagnetic semiconductor material due to Mn (or Cr) dopants. The duration of the ultrashort laser pulses is preferably as small as possible. In addition, the peak power of the ultrashort pulses is preferably as high as possible, and the average power of the laser beam is preferably as small as possible. More preferably, the duration of the ultrashort laser pulses is about 2 picoseconds or less in duration. Transient carriers comprise photogenerated non-equilibrium carriers that have finite lifetimes. Preferably, the light source has a predetermined pulse pattern in exposing the light to the ferromagnetic semiconductor material. The predetermined pulse pattern includes the laser duration and the intervals between the pulses. The pattern is the bit pattern of the information to be recorded, and the smallest possible interval is preferred. In addition, the laser pulses preferably have a predetermined wavelength. The wavelengths for the laser pulses can be between about 0.3 micrometers and about 5 micrometers. Preferably, the wavelengths are determined by the band gap of the ferromagnetic semiconductor material, with the photon energy the same or larger than the band gap of the ferromagnetic semiconductor material. More preferably, the photon energy is about the same as the band gap of the ferromagnetic semiconductor material.

The ferromagnetic semiconductor material is exposed to the laser pulses when the ferromagnetic semiconductor material is at a temperature below its T_{c}. Therefore, the ferromagnetic semiconductor material is preferably cooled to a temperature below its T_{c} before or simultaneous (preferably before) to exposure to the laser pulses. The ferromagnetic semiconductor material can be cooled to any temperature below its T_{c} preferably to a temperature at which the remanence is a significant fraction (>80%) of the saturation magnetization and the coercivity is a significant fraction (>80%) of the lowest temperature value. Methods for cooling the ferromagnetic semiconductor material are well known in the art, and the ferromagnetic semiconductor material of the present invention can be cooled by any such methods. Examples of such methods include thermo-electrical cooling based on the Peltier effect. It is to be understood that the cooling step is optional if the ferromagnetic semiconductor material is already below its T_{c}. The ultrashort pulse of light can be from any suitable light source.

The method can optionally comprise a second set of laser pulses (“probe” pulses) having a predetermined wavelength and pulse pattern, wherein such pulse pattern is the same as that of the first set (“pump” pulses) used to expose the ferromagnetic semiconductor material whereas the probe wavelength can be different from the pump wavelength. Using two sets of laser pulses is well known in the art and is typically known as pump-and-probe spectroscopy. For instance, the probe pulses provide information such as coercivity and carrier lifetimes of the ferromagnetic semiconductor material and the like.

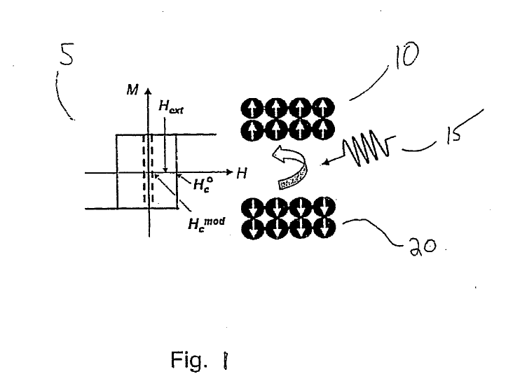

FIG. 1 illustrates a non-thermal method for recording information on a III-V ferromagnetic semiconductor material. Diagram 5 comprises a magnetic field axis H and a magnetization axis M. Diagram 5 further comprises an H_{c}⁰, an expected H_{c}^{mod}, and an Hₑₓₜ. Before being exposed to the laser pulses, the coercivity of the ferromagnetic semiconductor material is at H_{c}⁰, and the magnetization direction of the ferromagnetic semiconductor material is pointing down at direction 20. When exposed to the laser pulses 15, the coercivity level of the ferromagnetic semiconductor material is reduced to H_{c}^{mod}, and the magnetization direction of the ferromagnetic semiconductor material reverses and points in the opposite direction 10 from its original direction 20.

The present invention also comprises a method for modifying the ferromagnetic semiconductor material, preferably to a storage medium. Such method comprises providing the ferromagnetic semiconductor material, wherein the ferromagnetic semiconductor material comprises at least one Group III element, at least one Group V element, and a dopant. The method further comprises exposing the ferromagnetic semiconductor material to laser pulses to produce transient carriers, wherein the transient carriers interact with the dopant to modify the ferromagnetic semiconductor material. In addition, such method comprises cooling the ferromagnetic semiconductor material to a temperature below its T_{c} before or simultaneous to (preferably before) exposing the cooled ferromagnetic semiconductor material to the ultrashort laser pulses. The ferromagnetic semiconductor material can be cooled by any of the methods noted above in the method for recording information. It is to be understood that the cooling step is optional if the ferromagnetic semiconductor material is already below its T_{c}. The laser pulses preferably comprise predetermined wavelengths and pulse patterns. It is to be understood that the predetermined wavelengths and pulse patterns comprise the wavelengths and pulse patterns noted above in the method for recording information. The ferromagnetic semiconductor material is exposed to the ultrashort light pulses in the presence of an external magnetic field Hₑₓₜ that is in the opposite direction to the original magnetization direction of the ferromagnetic semiconductor material. As noted above, Hₑₓₜ is less than H_{c}⁰.

The present invention also provides a method for providing transient decrease in the coercivity in a hysteresis loop of a ferromagnetic III-V semiconductor material. Hysteresis loops that appear in the magnetic field (H) dependence of magnetization (M) are well known in the art and are characteristic of ferromagnetic materials (or permanent magnets). The existence of a hysteresis loop in an M-H curve indicates that material has spontaneous magnetization. After one applies and then removes a magnetic field pointing upward to the material, it remains magnetized in that direction and typically takes a large magnetic field pointing downward (larger than the coercivity) to reverse the net magnetization. The horizontal size (width) of the loop is the coercivity and the vertical size (height) of the loop is the saturation magnetization. Such method comprises exposing the ferromagnetic semiconductor material to ultrashort laser pulses, which produces transient carriers within the ferromagnetic semiconductor material. It has been discovered that the coercivity decreases when exposed to ultrashort laser pulses. Moreover, it has been discovered that the hysteresis loop has no change in the vertical direction when exposed to the ultrashort laser pulses, which further confirms the non-thermal nature of this method since heating would decrease both the horizontal and vertical sizes of the hysteresis loop. Without being limited by theory, it is believed that such suppression in the horizontal direction without a corresponding change in the vertical direction shows that no heat transfer to the ferromagnetic semiconductor material occurs. The ultrashort laser pulse preferably has the predetermined wavelength and pulse pattern noted above. If the temperature of the ferromagnetic semiconductor material is not below its T_{c}, its temperature is cooled to below its T_{c} according to the methods noted above. Preferably, the ferromagnetic semiconductor material is exposed to the ultrashort laser pulses in the presence of an external magnetic Hₑₓₜ, which has a direction opposite to that of the magnetization direction of the ferromagnetic semiconductor material and has a strength less than H_{c}⁰ and greater than H_{c}^{mod}. Such method can also comprise the second set of laser pulses that overlap the first set of laser pulses, which identify information such as changes in the coercivity. It is to be understood that this second set of laser pulses comprises all of the limitations of the second set of laser pulses described above.

To further illustrate various illustrative embodiments of the present invention, the following examples are provided.

### EXAMPLES 1-3

A two-color time-resolved magneto-optical Kerr effect (MOKE) spectroscopy experiment was performed using femtosecond (˜150 fs) pulses of mid-infrared (MIR) and near-infrared (NIR) radiation. The source of intense MIR pulses was an optical parametric amplifier (OPA) pumped by a Ti:Sapphire-based chirped pulse amplifier (CPA). The OPA was able to produce tunable and intense radiation from 522 nm to 20 μm using different mixing crystals. A small fraction (˜10⁻⁵) of the CPA beam (775 nm) was used as a probe, and the output beam from the OPA tuned to 2 μm was used as the pump. The two beams were made collinear by a non-polarizing beam splitter and then focused onto the sample mounted inside a superconducting magnet with optical windows. The intensity difference of the s- and p-components of the reflected NIR beam as well as its total intensity as functions of time delay and magnetic field were recorded. The sample was an InMnAs/GaSb single heterostructure with a T_{c} of 55 K, comprising a 25 nm thick In_{0.91}Mn_{0.09}As magnetic layer and an 820 nm thick GaSb buffer layer grown on a semi-insulating GaAs (100) substrate. The sample's room temperature hole density and mobility were 1.1×10¹⁹ cm⁻³ and 323 cm²/Vs, respectively. The magnetization axis was perpendicular to the epilayer due to the strain-induced structural anisotropy caused by the lattice mismatch between InMnAs and GaSb. Such magnetization allowed observation of ferromagnetic hysteresis loops in the polar Kerr configuration.

### Example 1

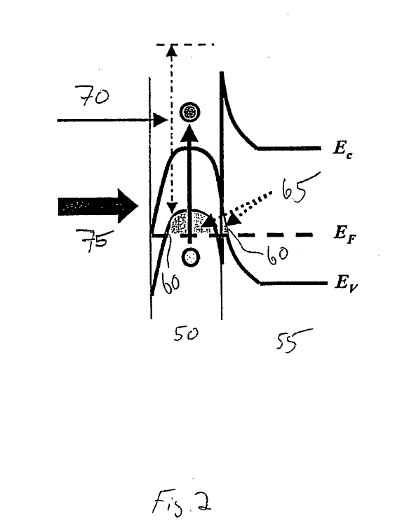

FIG. 2 illustrates a schematic band diagram of the InMnAs/GaSb sample studied. Surface pinning of the Fermi energy and the type-II “broken-gap” alignment between As 50 and GaSb 55 produces large band bending. Such bending together with Mn doping creates two pockets 60 for holes 65. Also shown in FIG. 2 is the pumping scheme used, which comprised NIR probe 70 and MIR pump 75. At the pump 75 wavelength (2 μm), the photon energy (0.62 eV) was smaller than the band gaps of GaSb 55 (0.812 eV) but was larger than that of InMnAs 50 (˜0.42 eV) and that the pump 75 created transient carriers only in the InAs layer 50. Under the pumping conditions, the maximum density of the photo-created transient carriers was estimated to be comparable to or larger than the background carrier density (˜10¹⁹ cm⁻³). Consequently, significant modifications in exchange interactions can be expected.

### Example 2

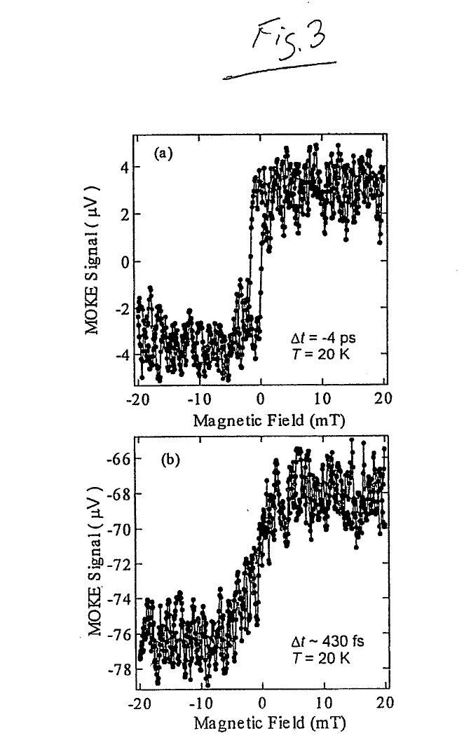

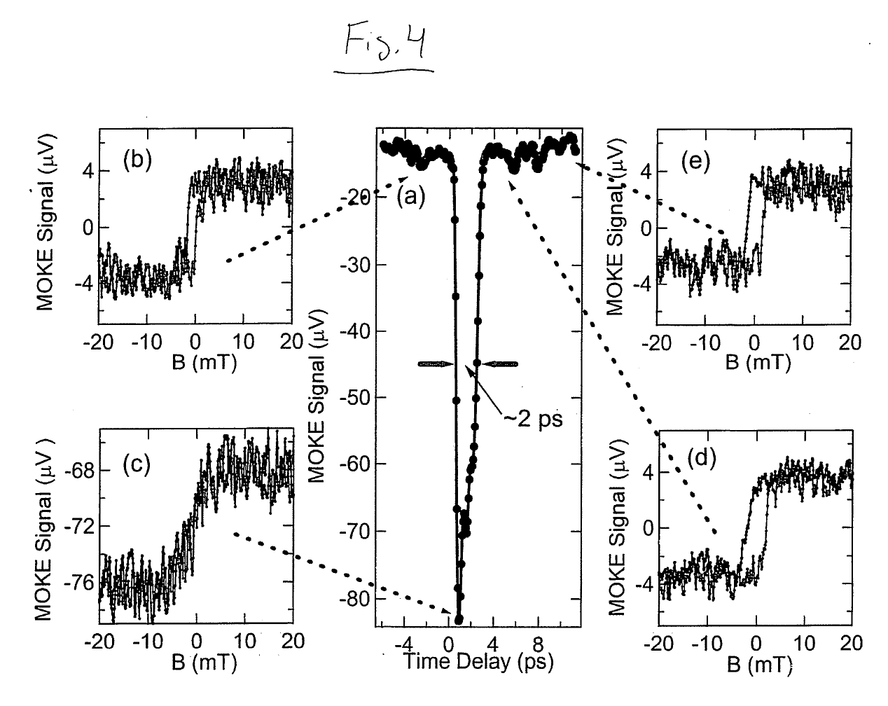

FIGS. 3(a) and (b) illustrate the magnetic field dependence of MOKE signal data showing the ultrafast softening process. Two magnetic field (B) scans exhibiting ferromagnetic hysteresis loops at 20 K are illustrated for −4 ps and 430 fs time delays in FIGS. 3(a) and 4(b), respectively. At 430 fs after time zero [FIG. 3(b)], it was observed that the hysteresis loop was substantially suppressed in the horizontal direction. Such substantial suppression indicates that the coercivity is almost zero. Further noted was that no substantial change was observed in the vertical size of the loop. Therefore, it is believed that simple lattice heating cannot be the reason for observations in this example as raising the lattice temperature should result in loop shrinkage both vertically and horizontally. Further observations indicated that the fluence of the ultrashort laser pulses determined the degree of collapse and not the average power.

### Example 3

FIGS. 4(a)-(e) illustrate photo-induced magnetization dynamics by showing photo-induced MOKE signals v. time delay at an applied field of −20 mT with a circularly polarized pump. An ultrafast photo-induced response was clearly observed. Ferromagnetic loops were plotted in FIGS. 4(b)-(e), which correspond to the fixed time delays indicated in FIG. 4(a). At time zero [FIG. 4(a)], it was observed that the hysteresis loop collapsed horizontally. It was further observed that the softening lasted only for a short time, around 2 ps. It was further observed that as the photo-induced NMOKE signal disappeared [FIG. 4(a)], the hysteresis loop returned with the original H_{c} recovered [FIGS. 4(d) and 4(e)].

None of the magnetic field scans in FIGS. 3 and 4 are offset, i.e., vertical shifts of the loops are a real effect. However, all of the data indicated that no magnetization change accompanied the vertical shift. Therefore, it is believed that the signal in time scans is not due to any change related to ferromagnetism but instead to the coherent spin polarization of the photo-generated carriers. Consequently, such time scans provide a direct measure of the spin lifetime of photo-generated carriers. Moreover, it was determined that the charge lifetime of the carriers is ˜2 ps by standard pump-probe techniques. It is believed that the short charge lifetime is probably due to anti-site defects introduced during low temperature MBE growth.

It is to be understood that the present invention is not limited to III-V ferromagnetic semiconductor materials. Instead, it is envisioned that the ferromagnetic semiconductor materials can be II-VI ferromagnetic materials or IV ferromagnetic materials. The II-VI materials can comprise at least one Group II element, at least one Group VI element, and a dopant. The Group IV materials can comprise at least one IV ferromagnetic element and a dopant.

Although the present invention and its advantages have been described in detail, it should be understood that various changes, substitutions and alterations may be made herein without departing from the spirit and scope of the invention as defined by the appended claims.

What is claimed is:

1. A storage medium, wherein the storage medium comprises a ferromagnetic semiconductor, comprising:
at least one Group III element;
at least one Group V element; and
a dopant, wherein the storage medium comprises an original coercivity and an expected photo-modified coercivity, and wherein the expected photo-modified coercivity is lower than the original coercivity.

2. The storage medium of claim 1, wherein the dopant comprises Mn or Cr.

3. The storage medium of claim 1, wherein the dopant comprises Mn.

4. The storage medium of claim 1, wherein the Group III and Group V elements comprise those elements having a curie temperature above room temperature.

5. The storage medium of claim 1, wherein the storage medium comprises Ga₁₋ₓMnₓAs, Ga₁₋ₓMnₓN (In_{0.53}Ga_{0.47})₁₋ₓMnₓAs, or In₁₋ₓMnₓAs.

6. The storage medium of claim 1, wherein the storage medium comprises Ga₁₋ₓMnₓN.

7. The storage medium of claim 1, wherein the Group V elements comprise about 50 molar % of the semiconductor material, and wherein a combination of the Group III elements and the dopant comprise about 50 molar % of the semiconductor material.

8. The storage medium of claim 7, wherein the dopant comprises 10 molar % or less of the Group III elements.

9. The storage medium of claim 1, wherein the semiconductor material is prepared in an external magnetic field that has a strength lower than that of the original coercivity but higher than that of the expected photo-modified coercivity.

10. A method for nonthermally recording information on a ferromagnetic semiconductor material, comprising:
(A) providing a ferromagnetic III-V semiconductor material, wherein the semiconductor material comprises at least one Group III element, at least one Group V element, and a dopant; and
(B) exposing the ferromagnetic semiconductor material to laser pulses to produce transient carriers.

11. The method of claim 10, wherein the ferromagnetic semiconductor material comprises an original coercivity and an expected photo-modified coercivity, and wherein the expected photo-modified coercivity is lower than the original coercivity.

12. The method of claim 10, further comprising cooling the semiconductor material to a temperature below its curie temperature prior to step (B).

13. The method of claim 10, wherein step (B) further comprises cooling the ferromagnetic semiconductor material to a temperature below its curie temperature.

14. The method of claim 10, wherein the dopant comprises Mn or Cr.

15. The method of claim 10, wherein the dopant comprises Mn.

16. The method of claim 10, wherein the Group III and Group V elements comprise those elements having a curie temperature above room temperature.

17. The method of claim 10, wherein the semiconductor material comprises Ga₁₋ₓMnₓAs, Ga₁₋ₓMnₓN, (In_{0.53}Ga_{0.47})₁₋ₓMnₓAs, or In₁₋ₓMnₓAs.

18. The method of claim 10, wherein the semiconductor material comprises Ga₁₋ₓMnₓN.

19. The method of claim 10, wherein the Group V elements comprise about 50 molar % of the ferromagnetic semiconductor material, and wherein a combination of the Group III elements and the dopant comprise about 50 molar % of the ferromagnetic semiconductor material.

20. The method of claim 19, wherein the dopant comprises 10 molar % or less of the Group III elements.

21. The method of claim 10, wherein step (B) further comprises exposing the ferromagnetic semiconductor material in an external magnetic field.

22. The method of claim 21, wherein the ferromagnetic semiconductor material comprises an original coercivity and an expected photo-modified coercivity, and wherein the external magnetic field has a strength lower than that of the original coercivity but higher than that of the expected photo-modified coercivity.

23. The method of claim 21, wherein the ferromagnetic semiconductor material has an original magnetization direction, and wherein the external magnetic field has a magnetization direction opposite to the original magnetization direction.

24. The method of claim 10, wherein the laser pulses are less than about 2 picoseconds in duration.

25. The method of claim 10, wherein the laser pulses have a predetermined wavelength and a predetermined pulse pattern.

26. The method of claim 10, wherein the laser pulses comprise a wavelength between about 0.3 micrometers and about 5 micrometers.

27. The method of claim 10, wherein the laser pulses have a photon energy the same or larger than the band gap of the ferromagnetic semiconductor material.

28. The method of claim 10, wherein the transient carriers interact with the dopant elements.

29. The method of claim 28, wherein the ferromagnetic semiconductor material comprises an original coercivity and an expected photo-modified coercivity that is lower than the original coercivity, and wherein the interaction reduces the coercivity of the ferromagnetic semiconductor material to that of the expected photo-modified coercivity.

30. The method of claim 10, further comprising
(C) exposing the ferromagnetic semiconductor material to a second set of laser pulses wherein the second set of laser pulses have the same pulse pattern as the laser pulses of step (B).

31. The method of claim 30, wherein the second set of laser pulses comprises a predetermined wavelength.

32. The method of claim 30, wherein the second set of laser pulses provide information on the ferromagnetic semiconductor material.

33. The method of claim 10, wherein the ferromagnetic semiconductor material comprises a hysteresis loop, and wherein step (B) produces a transient decrease in the coercivity in the hysteresis loop.

34. The method of claim 10, wherein step (B) increases the density of transient carriers in the ferromagnetic semiconductor material.

35. A method for nonthermally modifying a ferromagnetic II-V semiconductor material, comprising:
(A) providing the ferromagnetic III-V semiconductor material, wherein the ferromagnetic semiconductor material comprises at least one Group III element, at least one Group V element, and a dopant; and
(B) exposing the ferromagnetic semiconductor material to laser pulses to produce transient carriers, wherein the transient carriers interact with the dopant to modify the ferromagnetic semiconductor material.

36. The method of claim 35, wherein the ferromagnetic semiconductor material comprises an original magnetization direction, and wherein modifying the ferromagnetic semiconductor material comprises reversing the direction of the original magnetization direction.

37. The method of claim 35, wherein the ferromagnetic semiconductor material comprises an original coercivity and an expected photo-modified coercivity, and wherein the expected photo-modified coercivity is lower than the original coercivity.

38. The method of claim 35, further comprising cooling the ferromagnetic semiconductor material to a temperature below its curie temperature prior to step (B).

39. The method of claim 35, wherein step (B) further comprises cooling the ferromagnetic semiconductor material to a temperature below its curie temperature.

40. The method of claim 35, wherein the dopant comprises Mn or Cr.

41. The method of claim 35, wherein the ferromagnetic semiconductor material comprises Ga₁₋ₓMnₓAs, Ga₁₋ₓMnₓN, (In_{0.53}Ga_{0.47})₁₋ₓMnₓAs, or In₁₋ₓMnₓAs.

42. The method of claim 35, wherein the dopant comprises 10 molar % or less of the ferromagnetic semiconductor material.

43. The method of claim 35, wherein step (B) further comprises exposing the ferromagnetic semiconductor material in an external magnetic field.

44. The method of claim 43, wherein the ferromagnetic semiconductor material comprises an original coercivity and an expected photo-modified coercivity, and wherein the external magnetic field has a strength lower than that of the original coercivity but higher than that of the expected photo-modified coercivity.

45. The method of claim 35, wherein the laser pulses have a predetermined wavelength and a predetermined pulse pattern.

46. The method of claim 35, wherein the laser pulses are less than about 2 picoseconds in duration.

47. The method of claim 35, further comprising
(C) exposing the ferromagnetic semiconductor material to a second set of laser pulses wherein the second set of laser pulses have the same pulse pattern as the laser pulses of step (B).

48. The method of claim 47, wherein the second set of laser pulses provides information on the ferromagnetic semiconductor material.

49. A method for providing a transient decrease of coercivity in a hysteresis loop of a ferromagnetic III-V semiconductor material, comprising:
(A) providing the ferromagnetic III-V semiconductor material, wherein the ferromagnetic III-V semiconductor material comprises at least one Group III element, at least one Group V element, and a dopant; and
(B) exposing the ferromagnetic III-V semiconductor material to ultrashort laser pulses having a predetermined wavelength to produce transient carriers within the ferromagnetic semiconductor material.

50. The method of claim 49, wherein the dopant comprises Mn or Cr.

51. The method of claim 49, further comprising cooling the ferromagnetic semiconductor material to a temperature below its curie temperature prior to step (B).

52. The method of claim 49, wherein step (B) further comprises cooling the ferromagnetic semiconductor material to a temperature below its curie temperature.

53. The method of claim 49, wherein the hysteresis loop is unchanged in the vertical direction.

54. The method of claim 49, further comprising
(C) exposing the ferromagnetic semiconductor material to a second set of laser pulses wherein the second set of laser pulses have the same pulse pattern as the laser pulses of step (B).

55. The method of claim 54, wherein the second set of laser pulses provide information on the ferromagnetic semiconductor material.

56. A method for increasing the carrier density in a ferromagnetic III-V semiconductor material comprising exposing the ferromagnetic semiconductor material to ultrashort laser pulses with a predetermined wavelength.

57. The method of claim 56, wherein the ferromagnetic semiconductor material further comprises Mn or Cr.
